(19) United States
(12) Patent Application Publication
(10) Pub. No.: US 2008/0040692 A1
(43) Pub. Date: Feb. 14, 2008

(54) GESTURE INPUT

(75) Inventors: Derek E. Sunday, Renton, WA (US); Chris Whytock, Seattle, WA (US)

Correspondence Address: BANNER & WITCOFF, LTD.;ATTORNEYS FOR CLIENT NOS. 003797 & 013797, 1100 13th STREET, N.W., SUITE 1200, WASHINGTON, DC, 20005-4051, US

(73) Assignee: Microsoft Corporation, Redmond, WA (US)

(21) Appl. No.: 11/427,684

(22) Filed: Jun. 29, 2006

(51) Int. Cl. G06F 3/033

(52) U.S. Cl. 715/863

(57) ABSTRACT

A variety of commonly used gestures associated with applications or games may be processed electronically. In particular, a user's physical gesture may be detected as a gesture signature. For example, a standard gesture in blackjack may be detected in an electronic version of the game. A player may thus hit by flicking or tapping his finger, stay by waving his hand and double or split by dragging chips from the player's pot to the betting area. Gestures for page turning may be implemented in electronic applications for reading a document. A user may drag or flick a corner of a page of an electronic document to flip a page. The direction of turning may correspond to a direction of the user's gesture. Additionally, elements of games like rock, paper, scissors may also be implemented such that standard gestures are registered in an electronic version of the game.

### BACKGROUND

The computing world is constantly striving to improve the realism with which users are able to interact with computing devices. Improving the realism of interaction allows a user to accomplish tasks without having to deviate from standard or accepted interactions, often increasing efficiency. In many applications, including video games, users and/or players must typically learn a new set of input rules in order to operate one or more elements of the application or game interface. For example, flipping a page in an electronic document often involves selecting a flip button using an input device such as a mouse. In another example, electronic blackjack games include a number of option buttons for hitting, standing/staying, doubling and splitting. However, having to learn new rules may discourage and/or dissuade users from using computing devices to accomplish everyday tasks and to engage in common activities.

### SUMMARY

Aspects are directed to a method and system for implementing standard or commonly used gestures in corresponding applications. For example, a hit, stand/stay and double or split gestures may be implemented in a blackjack game application or program. A hit gesture may correspond to a flick toward a player or a tapping motion while a stand/stay gesture may include a waving motion by a player's hand. Doubling or splitting may be initiated by dragging a number of chips from a user's chip pot to a predefined area in the user interface. Determining whether a player wants to double or split may involve detecting an additional gesture that corresponds to one action or the other. Default rules may also be used in the event the user does not enter an additional gesture input. A player's gesture and corresponding action may be confirmed by an interface to insure appropriate processing. Gestures may be captured in a variety of ways including using motion capture devices and touch sensitive input systems.

In another aspect, gestures associated with flipping pages of a document or book may be implemented in electronic applications for reading a document or book. The gestures may include dragging a user's finger across a page or flicking the user's finger in a specified area of the document. In one example, a page of a document may include one or more curled or folded corners that indicate a gesture input area. The curled or folded corners may further provide indication to a user as to whether the document may be turned or flipped in that direction. By detecting flicking or dragging of the curled or folded corners, the interface may determine that the user wishes to turn the page. The direction of a user's gesture may be relevant in determining whether a document should be turned forward or backward. For example, a user may drag her finger from the bottom right corner of a document toward the left. This may correspond to a forward turning or flipping action. In some instances, the entire document and/or interface may receive gesture inputs. The direction of flipping or turning may be configurable and customizable by a user.

In yet another aspect, an electronic version of the game rock, paper, scissors may recognized gestures corresponding to each element of the game (i.e., rock, paper and scissors). A rock may be represented by a clenched fist while a paper gesture may include flattening a player's hand with the palm facing up or down. Scissors, on the other hand, may be represented by a player making a fist while extending the middle and pointer fingers. Additional elements that may be added into the game may also be similarly imitated by a commonly used or standard gesture.

In yet another aspect, gestures may be detected using an optical input device. The optical input device may translate physical gestures into gesture signatures. Gesture signatures may include a pattern of light and dark that corresponds to the gesture entered. Pre-stored and/or predefined gesture signatures and/or characteristics thereof may be used to determine whether a user's gesture corresponds to a specific command and/or function.

According to yet another aspect, a magnitude and/or speed of a gesture may affect the resulting action. For example, in flipping a page, the magnitude, i.e., displacement of a user's gesture may correspond to a number of pages to turn. Thus, the greater the magnitude of the gesture, the more pages that are turned and vice versa. The speed of a user's gesture may also be used to determine the number of pages to turn. Faster motions or gestures may correspond to a greater number of pages to turn while slower gestures may indicate a smaller number of pages. An interface may also use a combination of speed and magnitude to determine the number of pages to turn.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Aspects of the invention are illustrated by way of example and not limited in the accompanying figures in which like reference numerals indicate similar elements and in which:

FIG. 1 illustrates a schematic diagram of a general-purpose digital computing environment in which one or more aspects may be implemented.

FIG. 2 is a diagram of a touch sensitive input device including a display screen and associated input devices according to one or more aspects described herein.

FIG. 3 is a diagram of a hardware environment configured to detect gesture input in which one or aspects may be implemented.

FIGS. 4A, 4B and 4C are diagrams of a gesture input device displaying a blackjack game environment and receiving blackjack gestures according to one or more aspects described herein.

FIG. 5 is a diagram of blackjack gestures and corresponding gesture signatures according to one or more aspects described herein.

FIG. 6 is a flowchart illustrating a method for processing blackjack gesture input according to one or more aspects described herein.

FIGS. 7A, 7B and 7C are diagrams of a gesture input device displaying an electronic document and receiving gesture input associated with manipulating the document according to one or more aspects described herein.

FIG. 8 is a diagram of page turning gestures and associated gesture signatures according to one or more aspects described herein.

FIG. 9 is a flowchart illustrating a method for processing document manipulation gestures according to one or more aspects described herein.

FIG. 10 is a diagram of elements of a rock, paper, scissors game and associated gesture according to one or more aspects described herein.

FIG. 11 is a diagram of rock, paper and scissors gestures and corresponding gesture signatures according to one or more aspects described herein.

### DETAILED DESCRIPTION

In the following description, reference is made to the accompanying drawings, which form a part hereof, and in which is shown by way of illustration various embodiments. It is to be understood that other embodiments may be utilized and structural and functional modifications may be made without departing from the scope of the present disclosure.

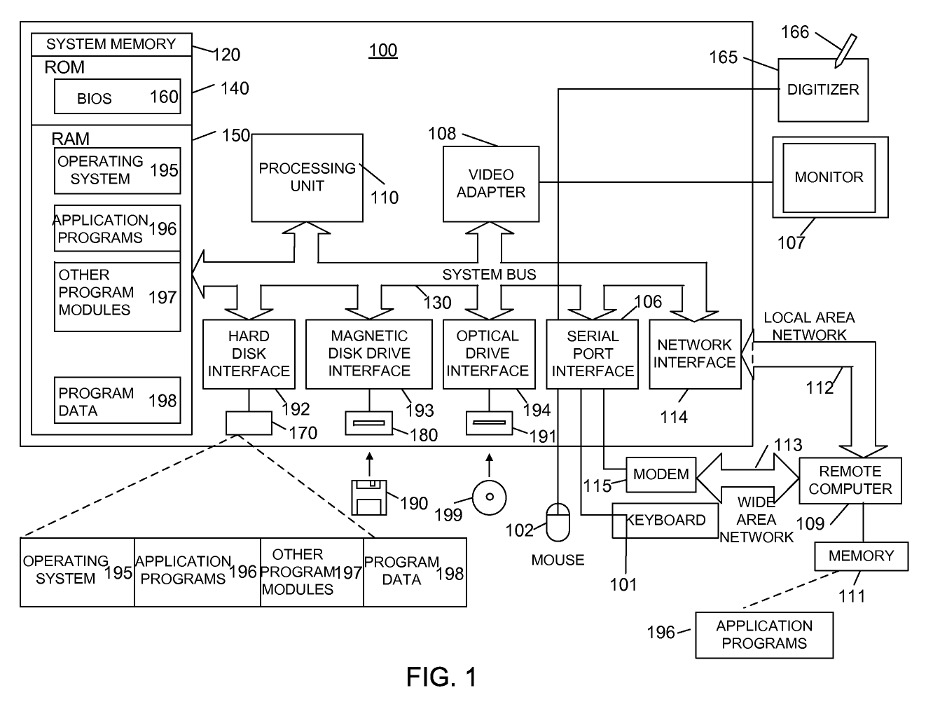

FIG. 1 illustrates a schematic diagram of a general-purpose digital computing environment. In FIG. 1, a computer 100 includes a processing unit 110, a system memory 120, and a system bus 130 that couples various system components including the system memory 120 to the processing unit 110. The system bus 130 may be any of several types of bus structures including a memory bus or memory controller, a peripheral bus, and a local bus using any of a variety of bus architectures. The system memory 120 may include read only memory (ROM) 140 and random access memory (RAM) 150.

A basic input/output system 160 (BIOS), which contains the basic routines that help to transfer information between elements within the computer 100, is stored in the ROM 140. The computer 100 also may include a hard disk drive 170 for reading from and writing to a hard disk (not shown), a magnetic disk drive 180 for reading from or writing to a removable magnetic disk 190, and an optical disk drive 191 for reading from or writing to a removable optical disk 199, such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. These drives and their associated computer-readable media provide nonvolatile storage of computer-readable instructions, data structures, program modules, and other data for the personal computer 100. It will be appreciated by those skilled in the art that other types of computer-readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 199, ROM 140, or RAM 150, including an operating system 195, one or more application programs 196, other program modules 197, and program data 198. A user can enter commands and information into the computer 100 through input devices, such as a keyboard 101 and pointing device 102 (such as a mouse). Other input devices (not shown) may include a microphone, joystick, game pad, satellite dish, scanner, or the like. These and other input devices often are connected to the processing unit 110 through a serial port interface 106 that is coupled to the system bus 130, but they also may be connected by other interfaces, such as a parallel port, game port, or a universal serial bus (USB), and the like. Further still, these devices may be coupled directly to the system bus 130 via an appropriate interface (not shown).

A monitor 107 or other type of display device also may be connected to the system bus 130 via an interface, such as a video adapter 108. In addition to the monitor 107, personal computers typically include other peripheral output devices (not shown), such as speakers and printers. In some example environments, a stylus digitizer 165 and accompanying stylus 166 are provided in order to digitally capture freehand input. Although a connection between the digitizer 165 and the serial port interface 106 is shown in FIG. 1, in practice, the digitizer 165 may be directly coupled to the processing unit 110, or it may be coupled to the processing unit 110 in any suitable manner, such as via a parallel port or another interface and the system bus 130 as is known in the art. Furthermore, although the digitizer 165 is shown apart from the monitor 107 in FIG. 1, the usable input area of the digitizer 165 may be co-extensive with the display area of the monitor 107. Further still, the digitizer 165 may be integrated in the monitor 107, or it may exist as a separate device overlaying or otherwise appended to the monitor 107.

The computer 100 can operate in a networked environment using logical connections to one or more remote computers, such as a remote computer 109. The remote computer 109 can be a server, a router, a network PC, a peer device or other common network node, and it typically includes many or all of the elements described above relative to the computer 100, although for simplicity, only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets, and the Internet, using both wired and wireless connections.

When used in a LAN networking environment, the computer 100 is connected to the local area network 112 through a network interface or adapter 114. When used in a WAN networking environment, the computer 100 typically includes a modem 115 or other means for establishing a communications link over the wide area network 113, such as the Internet. The modem 115, which may be internal or external to the computer 100, may be connected to the system bus 130 via the serial port interface 106. In a networked environment, program modules depicted relative to the personal computer 100, or portions thereof, may be stored in the remote memory storage device.

It will be appreciated that the network connections shown are examples, and other techniques for establishing a communications link between computers can be used.

The existence of any of various well-known protocols such as TCP/IP, Ethernet, FTP, HTTP, UDP, and the like is presumed, and the computer 100 can be operated in a user-server configuration to permit a user to retrieve web pages from a web-based server. Any of various conventional web browsers can be used to display and manipulate data on web pages.

Although the FIG. 1 environment shows one example environment, it will be understood that other computing environments also may be used. For example, an environment may be used having fewer than all of the various aspects shown in FIG. 1 and described above, and these aspects may appear in various combinations and subcombinations that will be apparent to one of ordinary skill. Additional elements, devices or subsystems also may be included in or coupled to the computer 100.

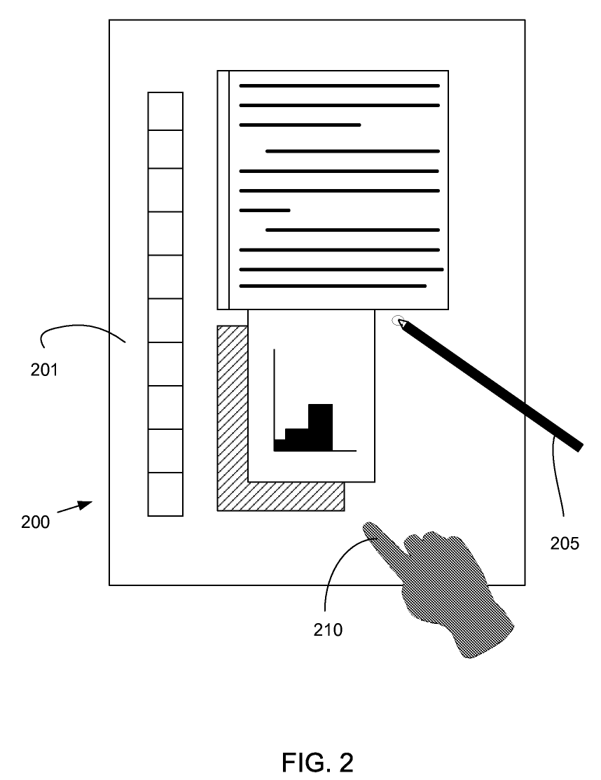

FIG. 2 illustrates a diagram of a touch sensitive input device 200 that may be implemented with a computing device like computer 100 of FIG. 1. Specifically, the touch sensitive input device includes a touch sensitive display screen 201, e.g. monitor 107 (FIG. 1) and peripherals such as stylus 205. Touch sensitive display screen 201 allows a user to enter input through screen 201 using a variety of input devices including stylus 205 and a user's finger 210. In one example, a user may enter text into a word processing application using a simulated keyboard displayed on touch sensitive screen 201. By contacting the portion of screen 201 corresponding to particular keys of the displayed keyboard, text corresponding to the key strokes may be inputted into the word processing application. In another example, a user may play a game such as solitaire or memory using the stylus to select and/or flip cards. Screen 201 may generate a variety of environments to simulate different applications. For example, screen 201 may display a blackjack table when a user initiates a blackjack program. In another example, screen 201 may generate a scrabble board for an electronic scrabble game. Alternatively or additionally, touch sensitive screen 201 may be configured to detect and process multiple simultaneous inputs from one or more users. In particular, screen 201 may allow a first user to interact with a first application while a second user is concurrently using a second application on the same screen 201.

In one or more arrangements, touch sensitive display screen 201 may further accept gesture input. That is, the system 200 may detect a user's gestures and translate them into application functions and/or commands. Gestures may be captured in a variety of ways including touch sensitive input devices and/or camera or optical input systems. Gestures generally refer to a user's motion (whether the motion is of the user's hand or a stylus or some other device) that is indicative of a particular command or request. Gestures and their corresponding meaning may be environment or application specific. For example, in blackjack, flicking or tapping one or more fingertips generally indicates that the user wants to hit (i.e., receive an additional card). Similarly, a user wishing to stay on a particular hand may wave her hand or fingers above her cards. Gestures may also correspond to desired interactions with a particular object. In one example, flipping a page of a document or book may be defined as a user's finger or hand movement from the bottom corner of one side of a document page toward the opposing side.

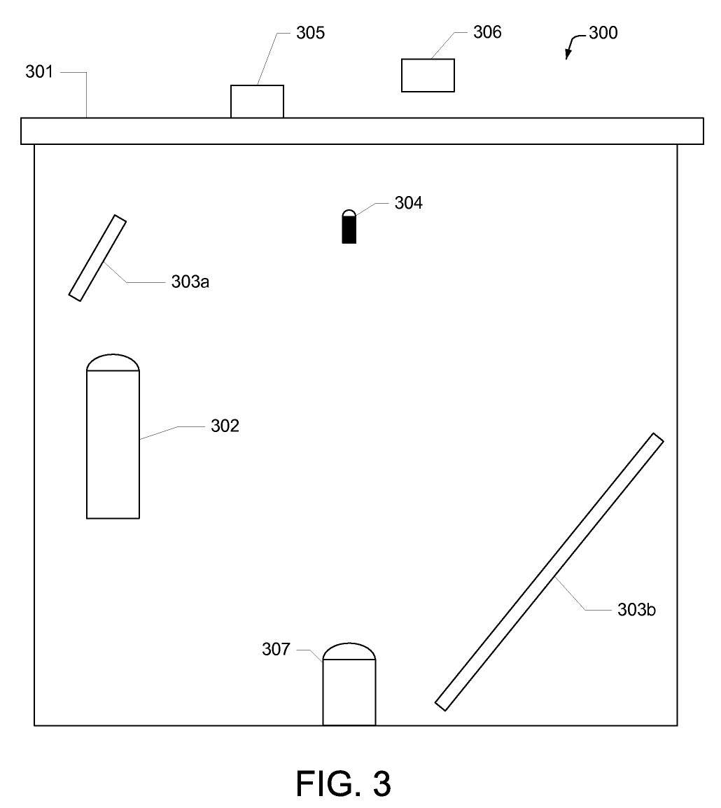

FIG. 3 illustrates a hardware environment configured to detect gestures. The computing device shown in FIG. 1 may be incorporated into a system having table display device 300, as shown in FIG. 3. The display device 300 may include a display surface 301, which may be a planar surface. As described hereinafter, the display surface 301 may also help to serve as a user interface. Display surface 301 may further include a touch sensitive display.

The display device 300 may display a computer-generated image on its display surface 301, which allows the device 300 to be used as a display monitor (such as monitor 107) for computing processes, displaying graphical user interfaces, television or other visual images, video games, and the like. The display may be projection-based, and may use a digital light processing (DLP—trademark of Texas Instruments Corporation) technique, or it may be based on other display technologies, such as liquid crystal display (LCD) technology. Where a projection-style display device is used, projector 302 may be used to project light onto the underside of the display surface 301. It may do so directly, or may do so using one or more mirrors. As shown in FIG. 3, the projector 302 in this example projects light for a desired image onto a first reflective surface 303a, which may in turn reflect light onto a second reflective surface 303b, which may ultimately reflect that light onto the underside of the display surface 301, causing the surface 301 to emit light corresponding to the desired display.

In addition to being used as an output display for displaying images, the device 300 may also be used as an input-receiving device. As illustrated in FIG. 3, the device 300 may include one or more light emitting devices 304, such as IR light emitting diodes (LEDs), mounted in the device's interior. The light from devices 304 may be projected upwards through the display surface 301, and may reflect off of various objects that are above the display surface 301. For example, one or more objects 305 may be placed in physical contact with the display surface 301. One or more other objects 306 may be placed near the display surface 301, but not in physical contact (e.g., closely hovering). The light emitted from the emitting device(s) 304 may reflect off of these objects, and may be detected by a camera 307, which may be an IR camera if IR light is used. The signals from the camera 307 may then be forwarded to a computing device (e.g., the device shown in FIG. 1) for processing, which, based on various configurations for various applications, may identify the object and its orientation (e.g. touching or hovering, tilted, partially touching, etc.) based on its shape and the amount/type of light reflected. To assist in identifying the objects 305, 306, the objects may include a reflective pattern, such as a bar code, on their lower surface. To assist in differentiating objects in contact 305 from hovering objects 306, the display surface 301 may include a translucent layer that diffuses emitted light, such as a semi-opaque plastic diffuser. Based on the amount of light reflected back to the camera 307 through this layer, the associated processing system may determine whether an object is touching the surface 301, and if the object is not touching, a distance between the object and the surface 301. Accordingly, various physical objects (e.g., fingers, elbows, hands, stylus pens, blocks, etc.) may be used as physical control members, providing input to the device 300 (or to an associated computing device).

The device 300 shown in FIG. 3 is illustrated as using light projection- and sensing techniques for the display of data and the reception of input, but other techniques may be used as well. For example, stylus-sensitive displays are currently available for use with Tablet-based laptop computers, and such displays may be used as device 300. Additionally, stylus- and touch-sensitive displays are available with many personal data assistants (PDAs), and those types of displays may also be used as device 300.

The device 300 is also shown in a substantially horizontal orientation, with the display surface 301 acting as a tabletop. Other orientations may also be used. For example, the device 300 may be oriented to project a display onto any desired surface, such as a vertical wall. Reflective IR light may also be received from any such oriented surface.

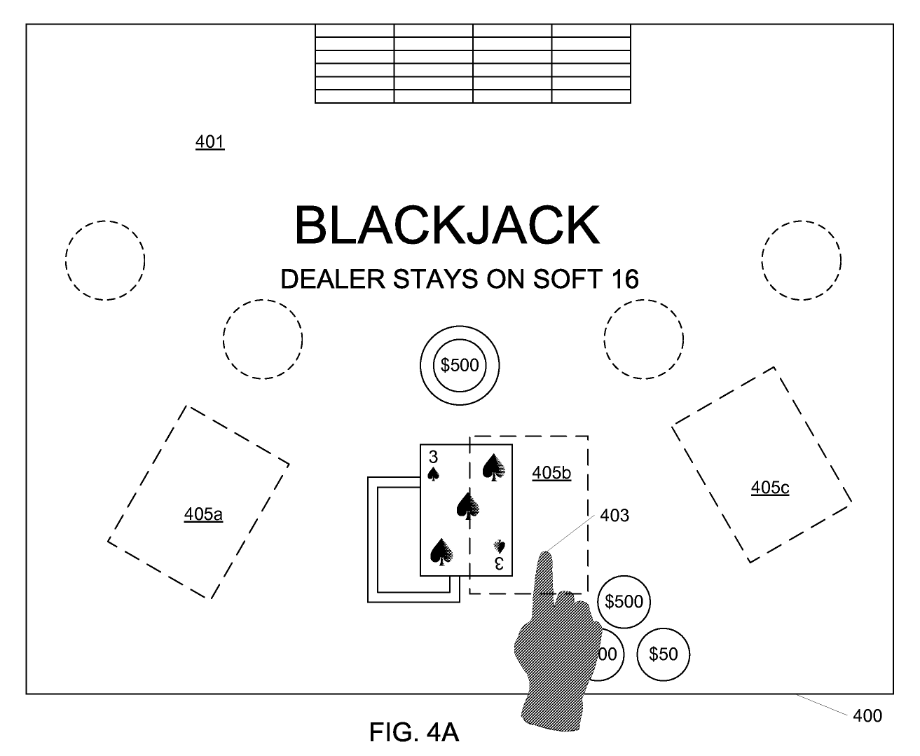

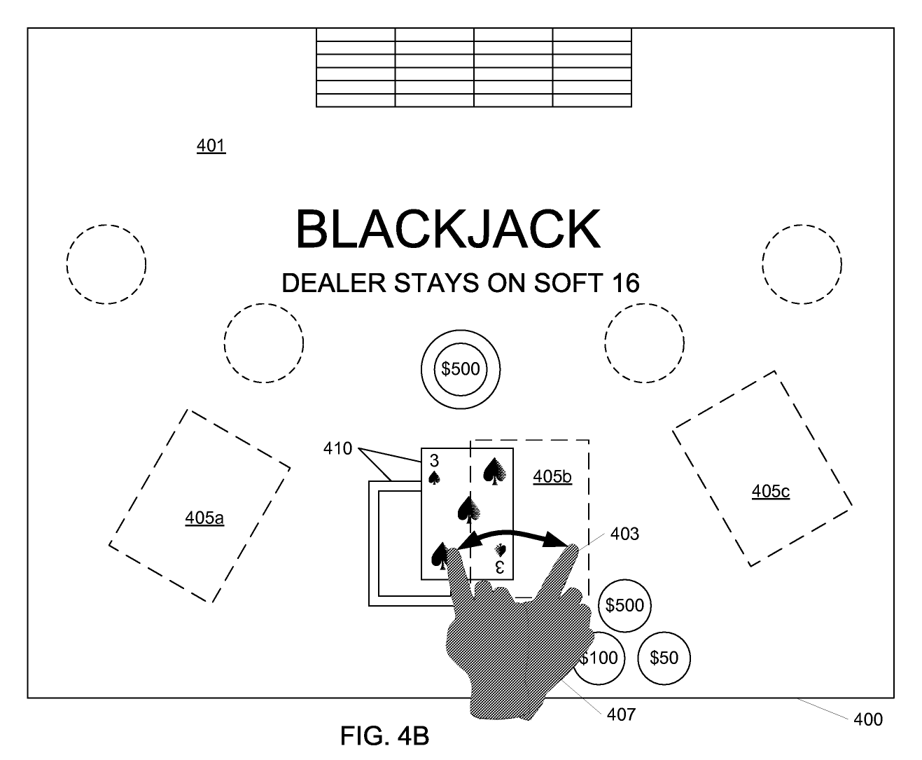

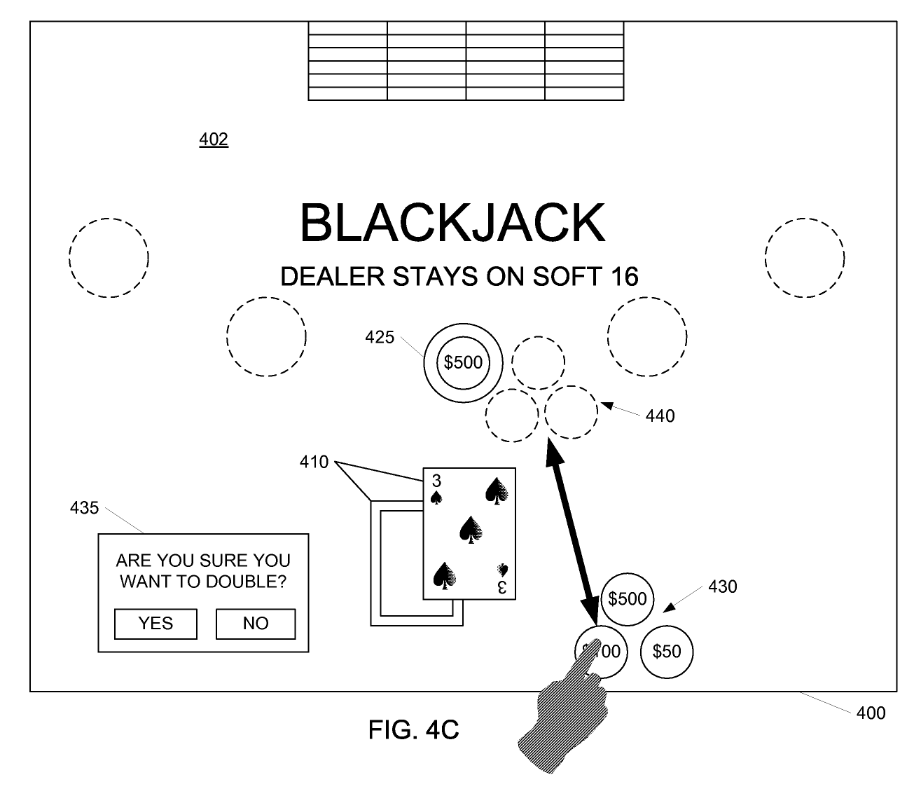

FIGS. 4A, 4B and 4C illustrate a gesture input device 400 (e.g., device 300 of FIG. 3) displaying a blackjack game interface 401 configured to detect and process gesture input. In FIG. 4A, a player makes a gesture with his finger 403 and/or hand that expresses a desire to hit, i.e., receive an additional card. The hit gesture may be characterized by tapping the surface of device 400 and/or a flicking motion toward the player. Flicking may refer to a player contacting a first area of interface 401 and sliding or moving his finger 403 backward toward the player. In addition to the player's finger 403, the player may also use her entire hand (e.g., as a fist) or a stylus to perform the gesture. Upon detecting the gesture, interface 401 may then perform a corresponding action, i.e., deal an additional card to the user. In one or more instances, the interface 401 may further confirm the player's request. Confirmation of gesture input is discussed in further detail with respect to FIG. 4C.

Alternatively or additionally, blackjack interface 401 may define an input area such as regions 405a, 405b and/or 405c for each player of the game. Gesture input detected in each area 405a, 405b and 405c may be associated with the particular player.

Interface 401 may require that gesture input be performed within these areas 405a, 405b and 405c in order to reduce the possibility that input may be ignored, left unregistered or erroneously processed. For example, a player may touch interface 301 for one or more reasons other than to express a blackjack command. However, without a specified area 405a, 405b or 405c for receiving gesture input, interface 401 may interpret the touch input as, for example, a hit request. Interface 401 may also set a specified time period within which a gesture is detected and processed. That is, interface 401 may require that all gestures be completed within, for example, 2 seconds of the initial input or of some other event (e.g., beginning of a player's turn). For example, a player may begin a hit gesture by contacting the surface of device 400 at a certain point. Once this initial contact is detected, the game interface 401 may determine a gesture based on input received within a 2 second period after detection of the initial contact. The time limit allows a user to “reset” his action if he decides that, prior to completing a gesture, he does not want to perform the action associated with the contemplated gesture.

FIG. 4B illustrates a gesture input associated with a stand/stay command in blackjack. The gesture may correspond to a waving motion of the player's hand 407, fingers and/or a stylus over or within a vicinity of the player's current cards 410. Alternatively or additionally, area 405b may be defined as a gesture input area. Any waving motion of the player's hand 407 within area 405b may register as a stand/stay command. However, motions outside of area 405b might not register or may register differently. For example, a waving motion outside of the boundaries of area 405b may register as a pause or stop game command. In addition or in place of the gesture input time limit discussed with respect to FIG. 4A, interface 401 may further determine a degree of a player's motion. For example, the degree of motion may be defined as the magnitude of displacement of the player's hand 407 in a particular direction. A threshold degree of motion may further be defined so that only player motions or gestures having a magnitude or degree meeting the predefined threshold are registered as a particular gesture. Implementing such a threshold guards against accidental activation of a command by very slight movements detected from the player.

FIG. 4C shows a player having the option of doubling or splitting his hand. Interface 402 displays a player's card hand 410, a bet 425 and a player's chips 430. Based on the make-up of card hand 410 and the rules of blackjack, a player may choose to double his bet 425 or split card hand 410. In one or more arrangements, the gesture associated with both doubling and splitting may be similar or identical. The gesture may include selecting an amount of chips from player's chips 430 and moving the selected chips to a position adjoining player's bet 425. In response to this gesture, interface 402 may either double hand 410 if, for example, hand 410 does not include a pair or a 2-of-a-kind. If hand 410 does include a pair or a 2-of-a-kind and: 1) hand 420 includes 2 aces, 2) the total value of hand 410 is high (e.g., 16 or higher) or 3) hand 410 is low (e.g., total value equal to 6 or under), interface 402 may automatically determine that the player wishes to split hand 410. If, however, hand 410 includes a 2-of-a-kind and the total value of the 2-of-a-kind is in middle, e.g., between 7 and 15, inclusive, interface 402 may request confirmation 435 from the player of his intended action or command. The predefined doubling and splitting conditions may be configured by the player upon joining a game or set as a default by the blackjack application. Alternatively, the interface 402 might always request confirmation of the user's intent.

Interface 402 may provide an indicator showing a player where to move a selected amount of chips to either initiate the double or split function. For example, interface 402 may display “ghost” stack 440 next to the player's current bet 425. The “ghost” stack 440 may include a faded outline of a stack of chips and/or a dashed or segmented outline defining the doubling/splitting area. Alternatively or additionally, interface 402 may define different gestures for each of the doubling and splitting commands, or different ghost stacks for each of the doubling and splitting options. For example, a user may be required to provide an additional gesture after dragging his chips to “ghost” stack 440 to indicate whether he wants to double or split. The gesture may include one or more taps in a single location to express a desire to double and/or two simultaneous taps (i.e., with two separated fingers) in different locations to express an intent to split. In one or more arrangements, if the player does not input the additional gesture within a specified period of time after dragging his chips to “ghost” stack 440, interface 402 may perform a default action according to one or more predefined rules based on rules and conventions in blackjack.

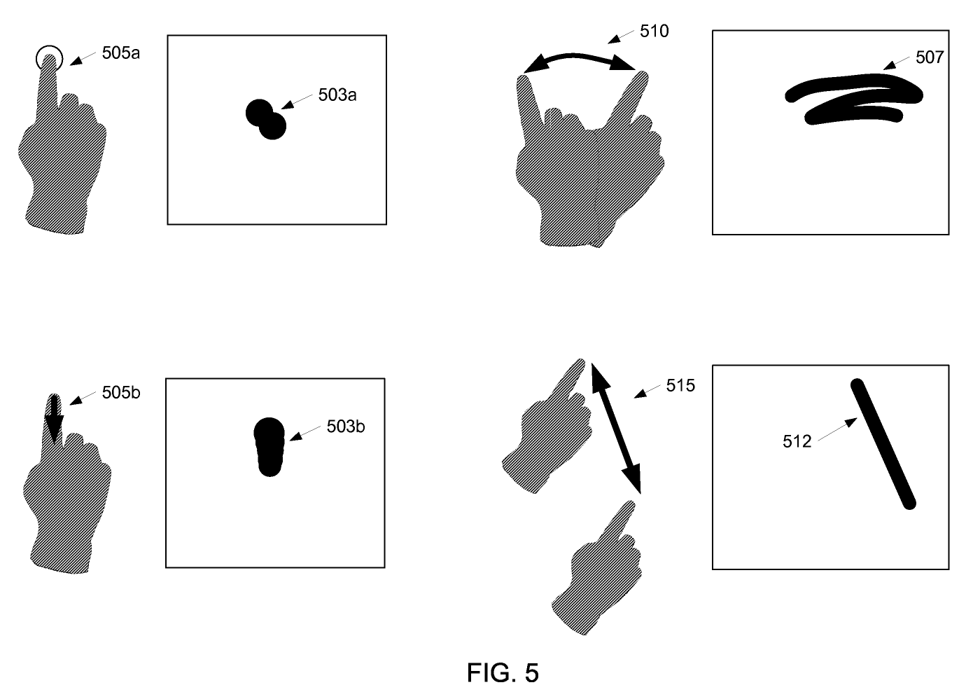

The gestures described with respect to FIGS. 4A, 4B and 4C may be detected using a variety of methods. In particular, a device such as device 300 of FIG. 3 may register a gesture signature associated with each of the gestures described in FIGS. 4A, 4B and 4C. Gesture signatures in general may relate to the signals or input detected by the input device when a user performs a particular gesture. In one example, device 300 (FIG. 3) may detect a resultant image from a user making a gesture over a light sensitive screen. A gesture signature may thus include a pattern of light and dark regions detected by the device 300. FIG. 5 illustrates gesture signatures 503a, 503b, 507, and 512 that may correspond to blackjack gestures 505a, 505b, 510 and 515. Hitting gestures 505a and 505b may correspond to gesture signatures 503a and 503b. In particular, hitting gesture 505a may include a tapping motion which may be registered as two circular shadows or dark regions 503a received one after the other by the input device. The two circular shadows or dark regions 503a may, for example, correspond to a user's finger tip contacting a surface of a gesture input device two or more consecutive times. Based on the detected gesture signature 503a and one or more predefined gesture signatures, a device may determine that hitting gesture 505a corresponds to a hit command. Similarly, a device may detect hitting gesture 505b as multiple circular shadows received in a sequence that when combined, forms dark backward stroke 503b. Again, the detected dark backward stroke 503b may be compared to a database of gesture signatures to determine a corresponding command and/or function.

Gestures 510 and 515 may be similarly identified based on corresponding gesture signatures 507 and 512, respectively. Gesture 510 may, in one or more instances, correspond to a stay/stand gesture that includes a user moving his finger side to side. To a gesture input device, gesture 510 may appear as a set of dark points that form a zig-zag line such as signature 507. In addition, gesture 515, which may include a dragging motion with a user's finger, may correspond to gesture signature 512. Gesture signature 512 registers as a line from one point to another. For example, gesture signature 512 may originate at a point within a player's pile of chips and end at a point next to the player's bet. The gesture signature 512 may thus be associated with either a double function or a split command.

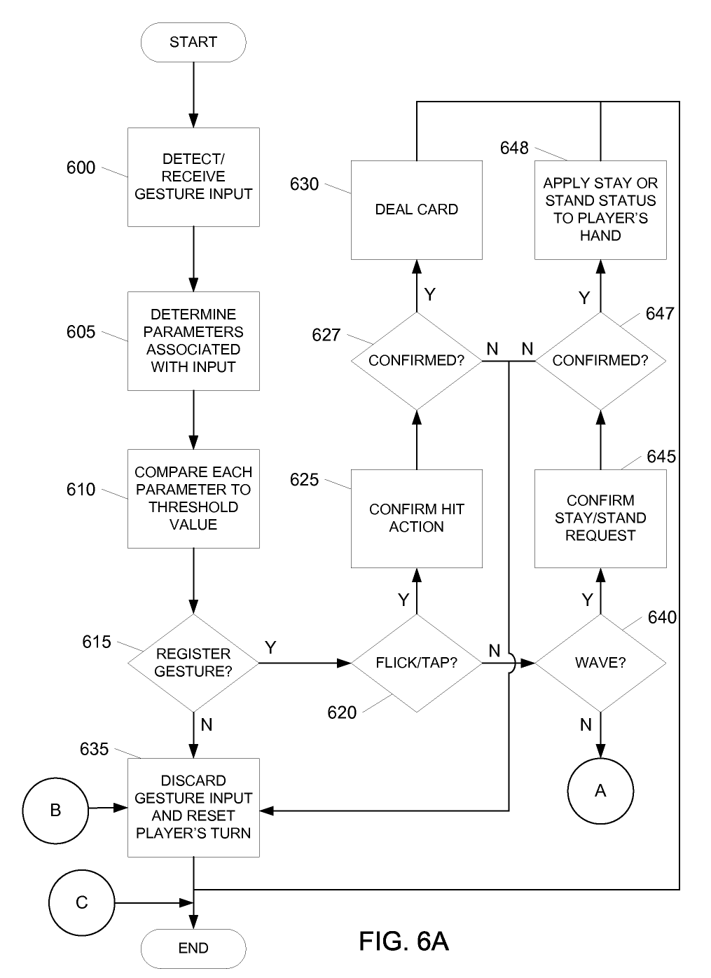

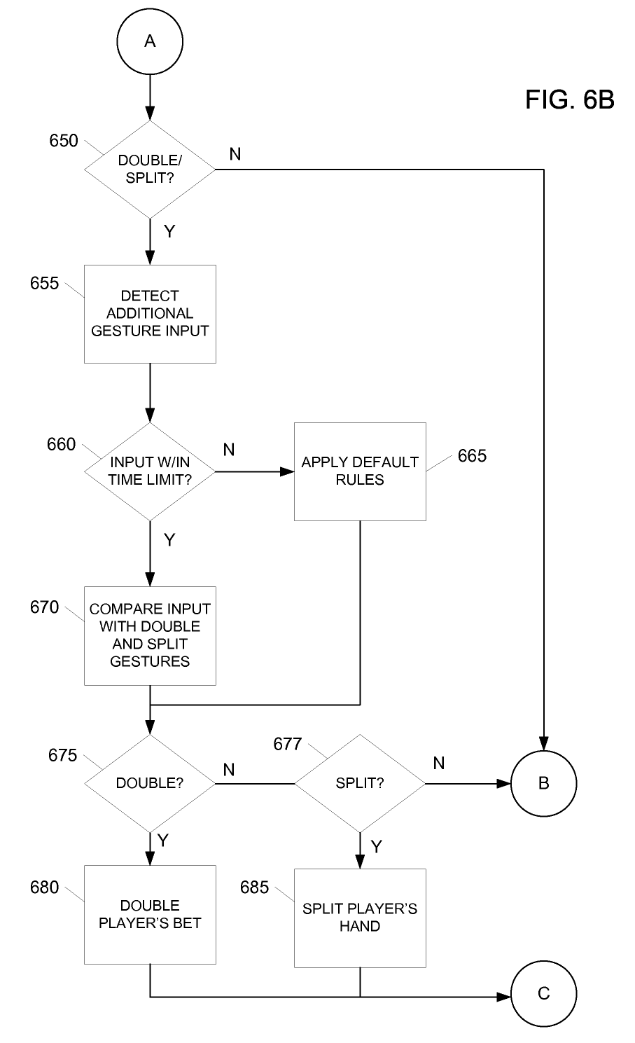

FIGS. 6A and 6B illustrate a flowchart showing a method for interpreting gestures in an electronic blackjack game. In step 600 of FIG. 6A, an interface may receive and/or detect a gesture input. For example, the interface may detect a waving gesture. The gesture may be detected using an optical capture device such as device 300. Additionally, a gesture may be detected as or represented by a gesture signature based on the user or player's actual gesture. In step 605, the interface may identify one or more parameters associated with the received gesture. The identified parameters may include a shape or configuration of the input, a speed of the gesture and a magnitude or displacement associated with the gesture. The identified parameters and the associated values may then be compared, in step 610, to a threshold value or baseline associated with each parameter. The threshold may be used to determine whether the gesture should be registered or ignored by the interface in step 615. Setting a speed or magnitude threshold may prevent unintentional or accidental entry of a command. If the interface determines to register the gesture, then the interface may further determine whether the gesture corresponds to a flick/tap motion or gesture associated with a hit command in step 620. Determining whether a gesture corresponds to a flick or tap motion may involve comparing the gesture signature associated with the detected gesture to one or more predefined and/or prestored gesture signatures associated with various commands and/or functions. If the gesture does correspond to the hit command, the interface may ask for and determine confirmation of the action in steps 625 and 627, respectively. The confirmation step may or may not be implemented depending on the user and/or system preference. If a player confirms the action, then in step 630 the player is dealt another card. If, however, the player does not confirm the hit action, then the gesture input may be discarded in step 635.

If the gesture does not correspond to the hit command (e.g., gesture signature does not correspond to predefined gesture signature associated with the hit command), then the interface determines whether the gesture corresponds to a stand/stay request in step 640. The stand/stay request may be associated with a waving motion of a player's hand. If the gesture does correspond to a stand/stay request, confirmation may be requested in step 645. If the request is confirmed in step 647, the interface may set that status of the player's hand as “STAY” or “STAND” in step 648. If, however, the player does not confirm the stand/stay request, then the gesture input may be discarded in step 635.

If the gesture input does not correspond to either the hit command or a stand/stay request, the interface may determine whether the gesture input is associated with a doubling or splitting gesture in step 650 of FIG. 6B. A doubling/splitting gesture may be characterized by an initial chip dragging action, moving chips from a player's chip area to a predefined area in the user interface. In one example, the predefined area may include a region next to the player's current bet. If the gesture input is associated with a doubling or splitting gesture, the interface may attempt to detect further gesture input in step 655. Again, an association between a gesture input and a command or function may be determined based on a gesture signature corresponding to the gesture input and one or more predefined gesture signatures associated with the command or function. The interface may further set a predefined amount of time for a user to enter further gesture input before implementing default rules in step 665 for determining whether to split or double. The interface may thus determine, in step 660, whether a player has entered gesture input within the predefined amount of time. If the player has not, the default rules are instituted in step 665. In one or more arrangements, a player's gesture may consist of only gesture input entered in the allotted time.

If, however, a player enters gesture input within the time limit, the gesture input may be compared to predefined gesture inputs associated with a double function and a split function in step 670. In step 675, the interface determines whether a double should be performed. If, based on either the default rules or the player's gesture input, the interface determines that a double should performed, the player's bet is doubled in step 680 and the player receives one more card. If, however, the interface determines that a split should be performed in step 677, the player's hand is split in step 685.

Prior to each of steps 680 and 685, the interface may request confirmation of the determined action from the player. Steps 680 and 675 might only be performed if confirmation is received. If confirmation is not received, all current gesture input may be discarded. Further, if the player's gesture does not correspond to either a double command or a split command, the input may be discarded and the player's turn reset in step 635 (FIG. 6A).

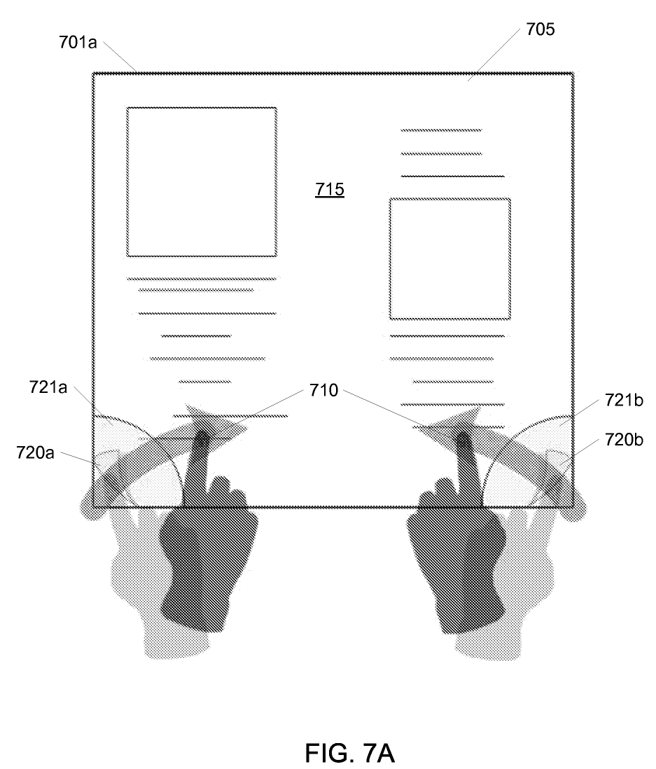

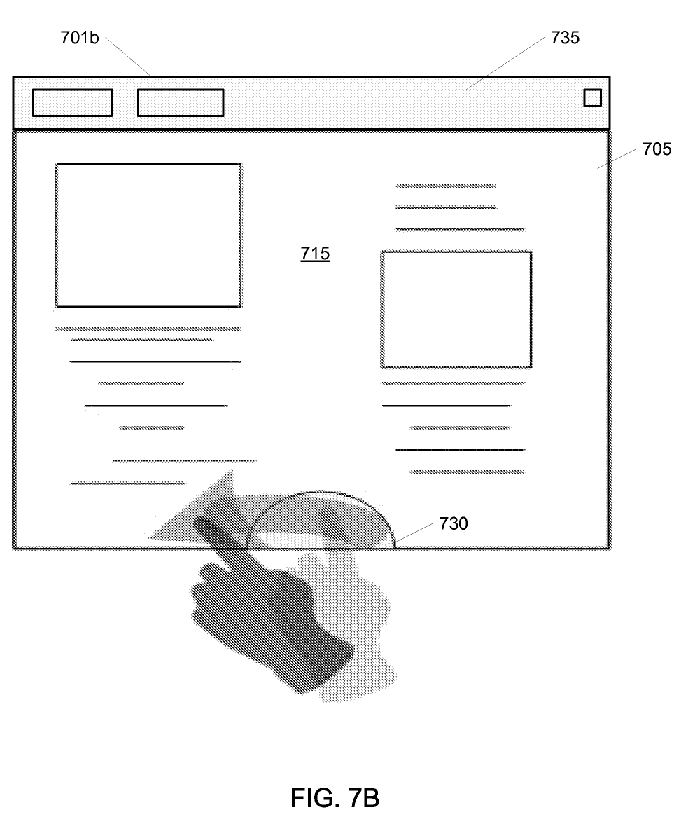

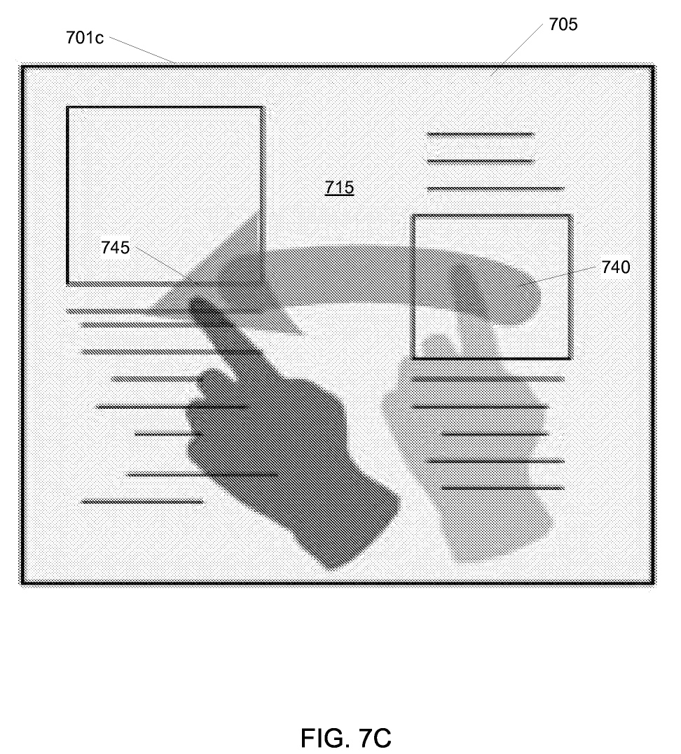

FIGS. 7A, 7B and 7C are diagrams of user interfaces 701a, 701b and 701c of a gesture input device 700 configured to detect and/or process user gestures. In each of FIGS. 7A, 7B and 7C, user interfaces 701a, 701b and 701c display an electronic document 705 that may be manipulated using a variety of gestures. In FIG. 7A, for example, a user may flip the pages, e.g., page 715, of document 705 by motioning, with her finger 710 or stylus (not shown), from the bottom corner of a current page 715 of document 705 toward the opposite corner or side of page 715. Alternatively or additionally, if document 705 displayed two opposing pages at the same time, a user may flip a right page by motioning or gesturing from the bottom right corner of the right page toward the left. Flipping backward would involve gesturing from the bottom left hand corner of the left page toward the right side.

The gesture associated with flipping or turning page 715 may include a flicking or dragging action. One or both actions may register as a flip command. Flicking, as used in the description of flipping or turning page 715, may be characterized by a movement of a user's finger 710 across a specified distance and/or at a specified speed. Dragging may be characterized by a movement of a user's finger 710 across a specified distance that is greater than the specified distance associated with flicking and/or at a specified speed. The flipping gestures may be inputted using either targets/hotspots or gesture regions 721a and 721b. Targets and hotspots may, in one or more instances, correspond to one or more page indicators 720a and 720b that inform the user whether pages before or after the current pages 715 and 716 exist. Examples of page indicators 720a and 720b include curled or folded corners. Thus, a user may flip page 715 forward and/or backward by gesturing at page indicators 720b and 720a, respectively. According to one or more aspects, gesture regions 721a and 721b that may be defined based on the locations of hotspots/indicators 720a and 720b. Implementing gesture regions 721a and 721b may facilitate gesturing input by users who may or may not have limited fine motor skills.

FIG. 7B illustrates a user interface 701b displaying page 715. Interface 701b further displays navigation panels 730 and 735. Navigation panels 730 and 735 provide a gesture region with which a user may control navigation (i.e., flipping forward and backward) through electronic document 705. Different gestures and commands may thus be inputted through a single gesture region/panel 730 or 735 instead of, for example, inputting a forward page flip in a first input region and a backward flip in a second input region. In order to differentiate between forward and backward flipping gestures, interface 701b may identify the direction of the gesture. For example, a left drag or flick may correspond to flipping a corresponding page like page 716 forward. Conversely, inputting a rightward flicking or dragging gesture may correspond to flipping page 715 backward. These left and right dragging or flicking gestures may be inputted in either region 730 or 735. In one or more arrangements, interface 701b might only display a single gesture region 730 or 735. Regions 730 and 735 may further be located in a variety of locations including in a menu bar or along the bottom edge of the display or interface 701b.

In FIG. 7C, no specific portion of page 715 or interface 701c is designated as a gesture input area. Instead, the entire page 715 may serve as a gesture area. As such, a user may flick or drag any point or area on page 715 toward either the left or the right to indicate a forward or backward flip, respectively. For example, a user may begin a flip gesture at a first point 740 of page 715 and motion toward the left, ending at a second point 745 of page 715. Interface 701c may interpret leftward gesture to indicate a forward flip.

Alternatively or additionally, the distance and/or velocity associated with the user's gesture may provide further parameters when flipping a page such as page 715. In one example, the distance that a user's flicks or drags may define a number of pages to flip. Thus, if a user's drag gesture extends across half of page 715, an interface 701a, 701b or 701c may flip document 705 forward 15 pages. In contrast, if the user's drag gesture extends across 1/4 of page 715, only 7 pages may be flipped. Further, the speed with which the user performs the flick or drag gesture may also be indicative of a number of pages to flip. That is, the faster a user performs a flick or drag gesture, the more pages that are flipped and vice versa. The association between speed and the number of pages may alternatively be reversed. Thus, in one example, the faster a user flicks or drags a page, the fewer pages that are flipped. In one or more arrangements, both the speed and the distance of the gesture may be combined to determine a number of pages to flip. A short slow gesture may correspond to a 1 page flip while a long fast gesture may be associated with a multi-page flip.

While the page flipping methods and systems described herein correspond a forward flip to a leftward motion and a backward flip to a rightward gesture, the reverse could also be implemented. This may be provide flexibility for documents in other languages that are read from right to left rather than left to right. In addition, the gestures corresponding to forward and backward flips may be configurable by a user based preferences.

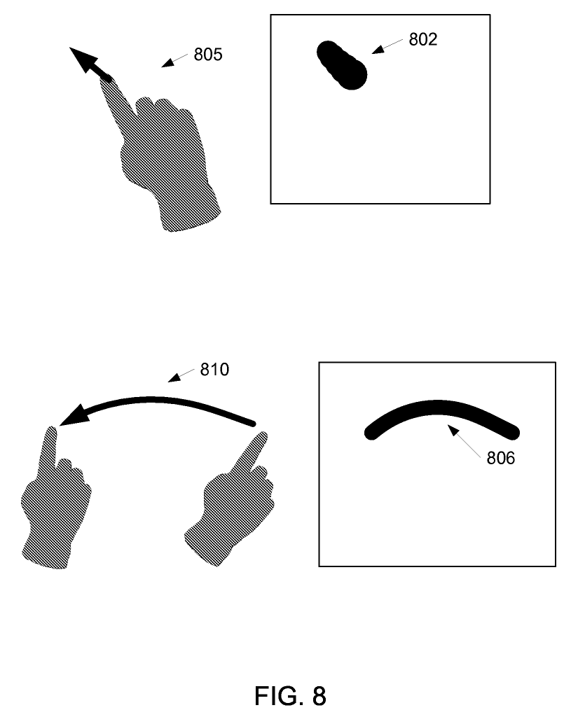

Each of the page flipping and/or turning gestures described herein may be detected and defined using gesture signatures. In FIG. 8, for example, gesture signatures 802 and 806 may correspond to page flipping and/or turning gestures 805 and 8 10. That is, gesture signatures 802 and 806 may be a resultant image detected based on a user performing a particular gesture on an optical input device such as device 300 of FIG. 3. Specifically, gesture 805 may include a flicking gesture or motion while gesture 810 may correspond to a dragging motion or action. Using an optical sensing device, flicking gesture 805 may be detected as gesture signature 802 having a short dark stroke of decreasing width. The decreasing width of stroke 802 may be due, in part, to a decreasing contact area of a user's finger as the finger is being lifted from the input surface (i.e., a characteristic of flicking motions). In contrast, dragging gesture 810 may be detected as line 806 that begins at one point in the document or page and ends at a second point. Based on the sequence of input (i.e., which points were detected first), the input device may further determine a direction of gesture 810 and signature 806.

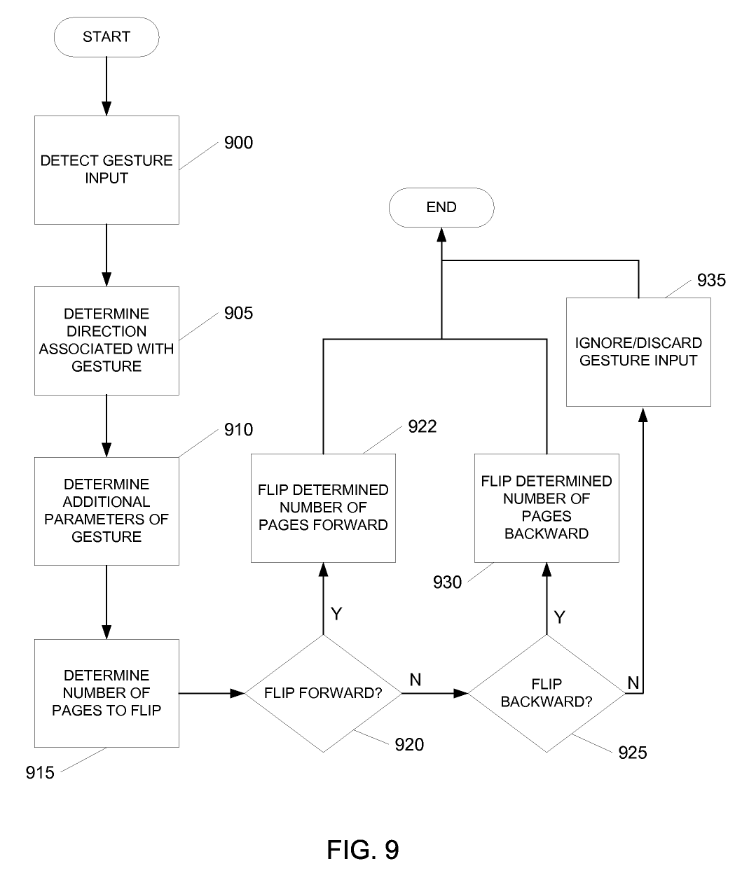

FIG. 9 is a flowchart illustrating a method for flipping pages of an electronic document through gesturing. In step 900, an interface may detect input corresponding to a gesture. For example, the interface may detect that a user is dragging his finger across the interface based on a gesture signature of the actual gesture. As discussed, gesture signatures may correspond to a detected dark or light regions created by a user's gesture. In step 905, the interface may determine a direction associated with the gesture. For example, the interface may identify the direction of the gesture based on an initial contact or gesture point and a last contact or gesture point. Additional parameters such as a magnitude (i.e., displacement) and speed or velocity of the gesture may also be determined in step 910. Either the speed or the magnitude of the gesture or both may be used to calculate a number of pages to flip in step 915. Upon determining the gesture direction and/or other parameters of the gesture, the interface may determine whether the gesture direction corresponds to a forward flip in step 920. For example, if the forward flip function is associated with a leftward gesture, then the interface may determine whether the gesture direction is leftward. In one or more arrangements, step 920 may further include comparing the gesture signature of the user's gesture with one or more predefined or prestored gesture signatures corresponding to page flipping or turning or data associated therewith. The comparison may be used to determine whether the user's gesture corresponds to page flipping or turning.

If the gesture direction does correspond to a forward flip, then the electronic document is flipped the calculated number of pages forward in step 922. If, however, the gesture direction does not correspond to a forward flip, a determination may be made in step 925 to determine whether the gesture direction corresponds to a backward flip. Again, the determination may be based on a predefined direction, e.g., right, associated with a backward flip action. If the gesture direction does correspond to a backward flip, then in step 930, the electronic document is flipped the calculated number of pages backward. If the interface is unable to determine whether the gesture direction corresponds to a forward flip or a backward flip, the gesture input may be ignored or discarded in step 935.

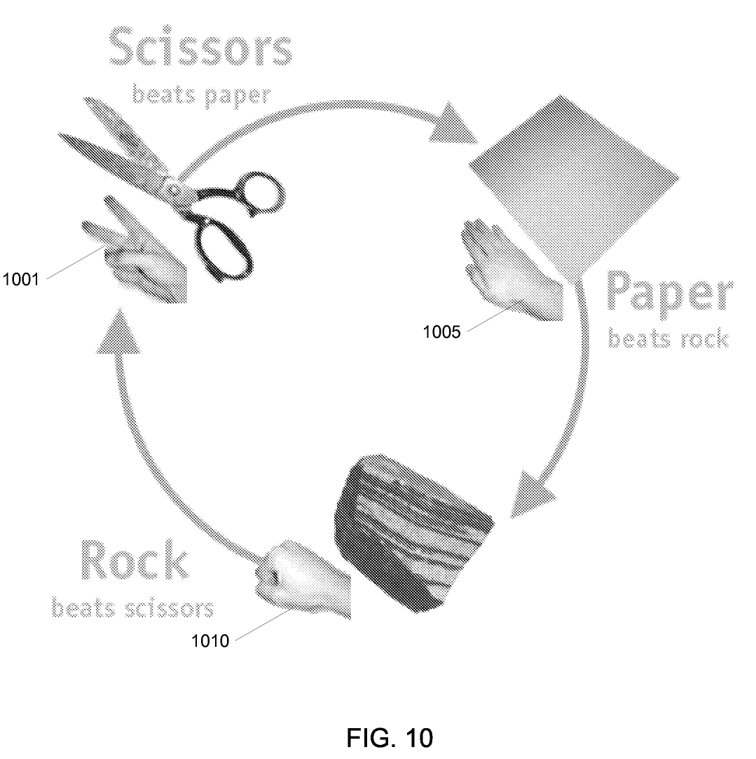

FIG. 10 illustrates the various gestures corresponding to different elements of a rock, paper, scissors game. In the game, a user may choose one of three elements: rock, paper or scissors. To choose the element, the user may imitate the appearance of the element with their hand. For example, a user may make a scissor gesture 1001 by extending her pointer and middle fingers. Alternatively, a user may choose the paper element with a gesture 1005 that includes opening up her hand flat with her palm facing up or down. In yet another alternative, a user may imitate the rock element by clenching her hand in a fist as shown in gesture 1010. Variations of rock, paper, scissors may include additional or alternative elements. The gestures associated with those elements may also be integrated into the game interface. For example, a commonly used gesture for fire may be programmed into the electronic version of the game.

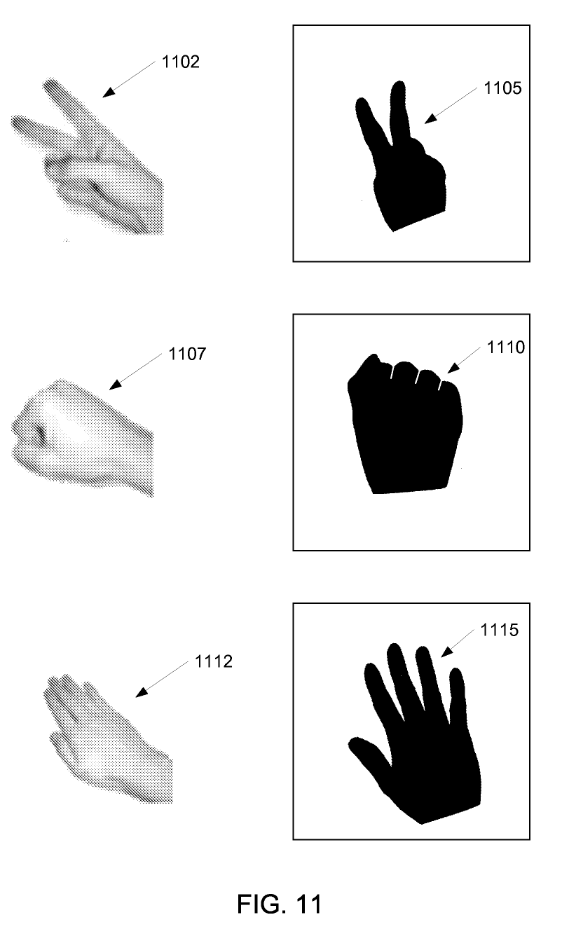

As with the blackjack and page turning gestures, the gestures associated with rock, paper, scissors may also be registered and predefined as gesture signatures 1105, 1110 and 1115 in FIG. 11. For example, gesture signature 1105 characterized by a circular dark region having two dark lines extending from the region may correspond to a scissor gesture 1102. Similarly, gesture signature 1110 may register as a large dark circular region which may correspond to a light reflection of a user's fist 1107. Paper gesture 1112 may be detected as a shadow representation 1115 of a user's open hand. Data associated with gesture signatures 1105, 1110 and 1115 may be stored in a database and retrieved for comparison in response to a user's gesture input. In one or more arrangements, a gesture signature 1105, 1110 or 1115 may be stored and compared to a user's gesture signature to determine a degree of similarity or correspondence. Based on the similarity, a device may or may not recognize the user's gesture as a command correspond to gesture signature 1105, 1110 or 1115. Alternatively or additionally, a device may store a series of gesture signature characteristics which may then be compared to a user's gesture or gesture signature.

The gestures described herein relate specifically to blackjack, flipping pages and playing a game of rock, paper, scissors. However, one of skill in the art will appreciate that many other accepted or standard gestures associated with various games, applications and functions may be implemented. For example, in electronic poker games, a player may indicate a number of cards she desires by holding up a corresponding number of fingers. The different gestures associated with the different number of fingers may be identified using prestored and/or predefined gesture signatures. In addition, many aspects described herein relate to touch sensitive input devices. However, other types and forms of gesture input devices may also be used in similar fashion. For example, motion detection cameras or optical input device may serve as gesture detection devices to capture gestures that are performed in mid-air and which do not contact a touch sensitive surface. Other input devices may include position tracking sensors that may be attached to, in one example, an input glove that a player or user wears. One of ordinary skill in the art will appreciate that numerous other forms of gesture detection devices and systems may be used in place of or in addition to the systems and devices discussed herein.

In addition, while much of the description relates to flipping or turning pages in an electronic document, one of skill in the art will appreciate that the gestures associated with flipping pages forward or backwards could also be implemented in applications other than document viewers. For example, internet browsers, media/music players, wizards, or other applications that have content on multiple screens/pages could also use these gestures as a means of navigating forward and backwards.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Numerous other embodiments, modifications and variations within the scope and spirit of the appended claims will occur to persons of ordinary skill in the art from a review of this disclosure.

We claim:

1. A method for entering commands in an electronic blackjack game, the method comprising:
detecting an initial gesture from a player;
determining whether the initial gesture corresponds to at least one of a hit gesture, a stay gesture, a double gesture and a split gesture;
in response to determining that the initial gesture corresponds to the hit gesture, dealing a card to the player;
in response to determining that the initial gesture corresponds to the double gesture, doubling a bet associated with the player; and
in response to determining that the initial gesture corresponds to the split gesture, splitting a card hand associated with the player.

2. The method of claim 1, wherein the initial gesture is detected as a gesture signature, wherein the gesture signature includes an optical pattern associated with the initial gesture.

3. The method of claim 2, wherein determining whether the initial gesture corresponds to at least one of a hit gesture, a stay gesture, a double gesture and a split gesture includes comparing the gesture signature to one or more prestored gesture signatures.

4. The method of claim 1, wherein the hit gesture includes at least one of a tapping motion and a flicking motion, wherein the flicking motion is performed toward the player.

5. The method of claim 1, wherein the stay gesture includes waving the player's open hand.

6. The method of claim 1, wherein the split gesture and the double gesture both include a dragging motion, where the dragging motion includes dragging one or more betting chips to a predefined area.

7. The method of claim 1, wherein determining whether the initial gesture corresponds to at least one of a hit gesture, a stay gesture, a double gesture and a split gesture further includes analyzing a player's card hand based on a predefined set of rules.

8. The method of claim 1, wherein in response to determining that the initial gesture corresponds to at least one of a hit gesture, a stay gesture, a double gesture and a split gesture, requesting, from the player, confirmation of a command corresponding to the initial gesture.

9. The method of claim 1, wherein determining whether the initial gesture corresponds to at least one of a hit gesture, a stay gesture, a double gesture and a split gesture further includes:
detecting a following gesture; and
determining whether the initial gesture corresponds to the double gesture based on the detected following gesture.

10. A method for processing gestures in an electronic document application, the method comprising:
detecting a gesture of a user;
determining whether the user's gesture corresponds to a page turning command;
in response to determining that the user's gesture corresponds to the page turning command, determining a direction of the gesture; and
turning a number of pages in the electronic document in accordance with the direction of the gesture.

11. The method of claim 10, wherein detecting a gesture of a user includes determining a gesture signature associated with the gesture.

12. The method of claim 11, wherein determining whether the user's gesture corresponds to a page turning command includes comparing the gesture signature to one or more prestored gesture signatures associated with page turning.

13. The method of claim 10, wherein determining whether the user's gesture corresponds to the page turning command includes determining whether the user's gesture includes at least one of a dragging gesture and a flicking gesture.

14. The method of claim 10, further including determining at least one of a speed of the gesture and a magnitude associated with the gesture.

15. The method of claim 14, further including determining whether to register the gesture based on whether the speed of the gesture meets a predefined threshold speed.

16. The method of claim 14, further including determining the number of pages to turn based on at least one of the speed of the user's gesture and the magnitude associated with the gesture.

17. The method of claim 10, wherein turning a number of pages in the electronic document in accordance with the direction of the gesture further includes:
determining whether the direction of the gesture corresponds to a left direction; and
in response to determining that the direction of the gesture corresponds to the left direction, turning the number of pages forward in the electronic document.

18. A method for processing user input in an electronic rock, paper, scissors game, the method comprising:
detecting a gesture from a player; and
determining whether the gesture corresponds to at least one of a rock gesture, a scissors gesture and a paper gesture, wherein the rock gesture includes a closed fist gesture, the scissors gesture includes an extended middle and pointer fingers gesture and the paper gesture includes an open hand gesture; and
registering a selection of the player in accordance with the determined gesture.

19. The method of claim 18, wherein the player's gesture is detected using at least one of an optical sensor device and a touch sensitive input device.

20. The method of claim 18, wherein detecting a gesture from a player further includes determining whether the gesture was received within a predefined area of a user interface associated with the electronic game.
